(19) United States
(12) Patent Application Publication
(10) Pub. No.: US 2002/0035790 A1
(43) Pub. Date: Mar. 28, 2002

(54) Hexagonal slide ruler

(76) Inventor: Sean Anderson Barton, Quincy, FL (US)

Correspondence Address: Peter Loffler, 1546-1 Metropolitan Boulevard, Tallahassee, FL, 32308, US

(21) Appl. No.: 09/954,687

(22) Filed: Sep. 17, 2001

Related U.S. Application Data
(60) Provisional application No. 60/235,182, filed on Sep. 25, 2000.

(51) Int. Cl. G09F 9/00

(52) U.S. Cl. 33/1 SB; 116/308; 116/321

(57) ABSTRACT

A hexagonal slide ruler for performing complex calculations such as the day of the week of a particular date, has six body members adapted to move relative to each other. The first body member has a first side with first indicia thereon and a second side with second indicia thereon. The second body member has a third side with third indicia for aligning the second indicia and a fourth side with fourth indicia thereon. The third body member has a fifth side with fifth indicia for aligning with the fourth indicia and a sixth side with sixth indicia thereon. The fourth body member has a seventh side with seventh indicia for aligning with the sixth indicia and an eighth side with eight indicia thereon. The fifth body member has a ninth side with ninth indicia for aligning with the eight indicia and a tenth side with tenth indicia thereon. The sixth body member has an eleventh side with eleventh indicia for aligning with the tenth indicia and a twelfth side having twelfth indicia for aligning with the first indicia.

This application claims the benefit of U.S. provisional patent application 60/235,182 filed on Sep. 25, 2000.

### BACKGROUND OF THE INVENTION

1. Field of the Invention

The present invention relates to a device capable of performing complex calculations such as the timing of cycles.

2. Background of the Prior Art

Devices for performing complex calculations, such as the day of the week or the moon phase on a particular day are known in the art. Typically, such devices are software programs that run on a computer or are a relatively complex machine that performs the task. If a user desires to perform a complex calculation and has the software and is at a computer, the task is relatively simple. However, if a computer is not available, then the user must employ one of the complex devices known. However, as such devices tends to be complex in design and manufacture, they tend to be expensive and are difficult to use, leaving the user with less than ideal options.

Therefore, there is a need in the art for a device that can quickly and accurately perform complex calculations such as the timing of chronological cycles, general physical calculations, etc., wherein the device is not unduly complex and is relatively inexpensive to build. The device must not rely on the availability of a computer for use and should be relatively simple to operate.

### SUMMARY OF THE INVENTION

The hexagonal slide ruler of the present invention addresses the aforementioned needs in the art. The hexagonal slide ruler provides for a device that accurately performs complex calculations such as the timing of chronological cycles, general physical calculations, etc. The device is of relatively simple design and construction and is relatively easy to use.

The hexagonal slide ruler is comprised of a first body member that has a first side with first indicia thereon and a second side with second indicia. The second body member has a third side with a third indicia for aligning with the second indicia and a fourth side with fourth indicia. The third body member has a fifth side with a fifth indicia for aligning with the fourth indicia and a sixth side with sixth indicia. The fourth body member has a seventh side with a seventh indicia for aligning with the sixth indicia and an eighth side with eighth indicia for. The fifth body member has a ninth side with a ninth indicia for aligning the eight indicia and a tenth side with tenth indicia. The sixth body member has an eleventh side with eleventh indicia for aligning with the tenth indicia and a twelfth side having twelfth indicia for aligning with the first indicia. At least one band can be used to encompass the first through sixth body members in order to allow them to move relative to each other. The at least one band can be permanently attached to one of the body members.

### BRIEF DESCRIPTION OF THE DRAWINGS

FIG. 1 is a perspective view of the hexagonal slide ruler.

FIG. 2 is a front elevation view of the first body member of the hexagonal slide ruler.

FIG. 3 is a front elevation view, flattened, of the second body member of hexagonal slide ruler.

FIG. 4 is a front elevation view, flattened, of the third body member of the hexagonal slide ruler.

FIG. 5 is a front elevation view, flattened, of the fourth body member of the hexagonal slide ruler.

FIG. 6 is a front elevation view, flattened, of the fifth body member of the hexagonal slide ruler.

FIG. 7 is a front elevation view of the sixth body member of the hexagonal slide ruler.

FIG. 8 is a front elevation view, flattened, of the hexagonal slide ruler calculating the days of the week for February of 1804.

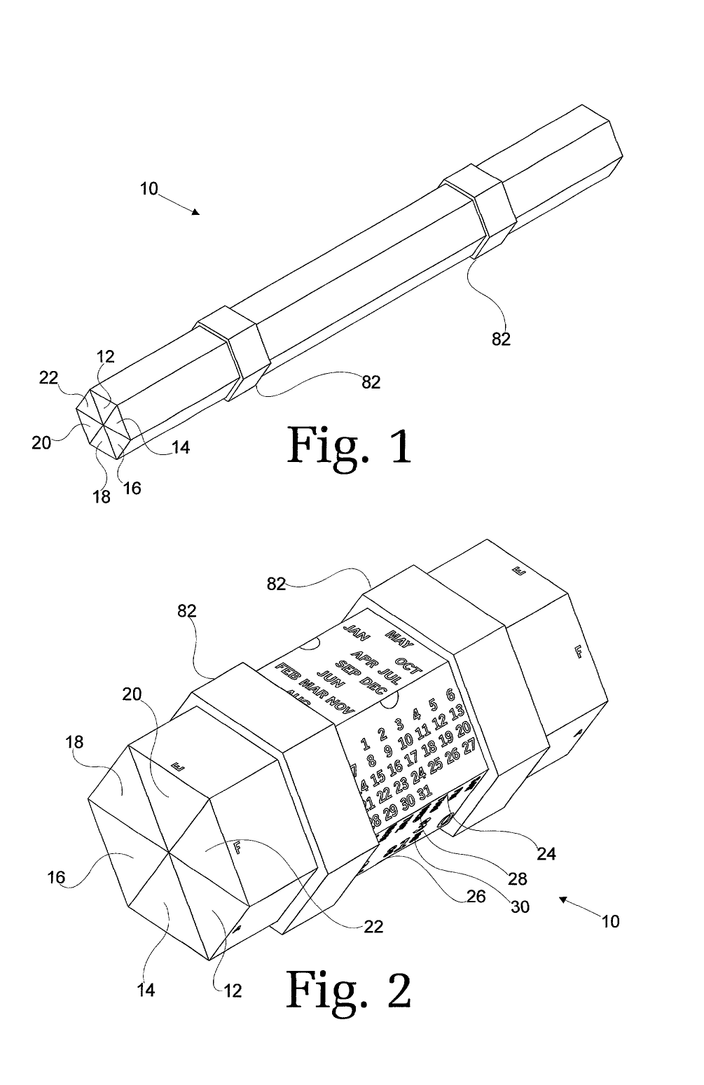

Similar reference numerals refer to similar parts throughout the several views of the drawings.

### DESCRIPTION OF THE PREFERRED EMBODIMENT

Referring now to the drawings, it is seen that the hexagonal slide ruler of the present invention, generally denoted by reference numeral 10, is comprised of a first body member 12, a second body member 14, a third body member 16, a fourth body member 18, a fifth body member 20 and a sixth body member 22. As seen each body member 12, 14, 16, 18, 20, and 22 is an elongate member that has a generally triangular shape (although each body member may have another appropriate shape such as rectangular).

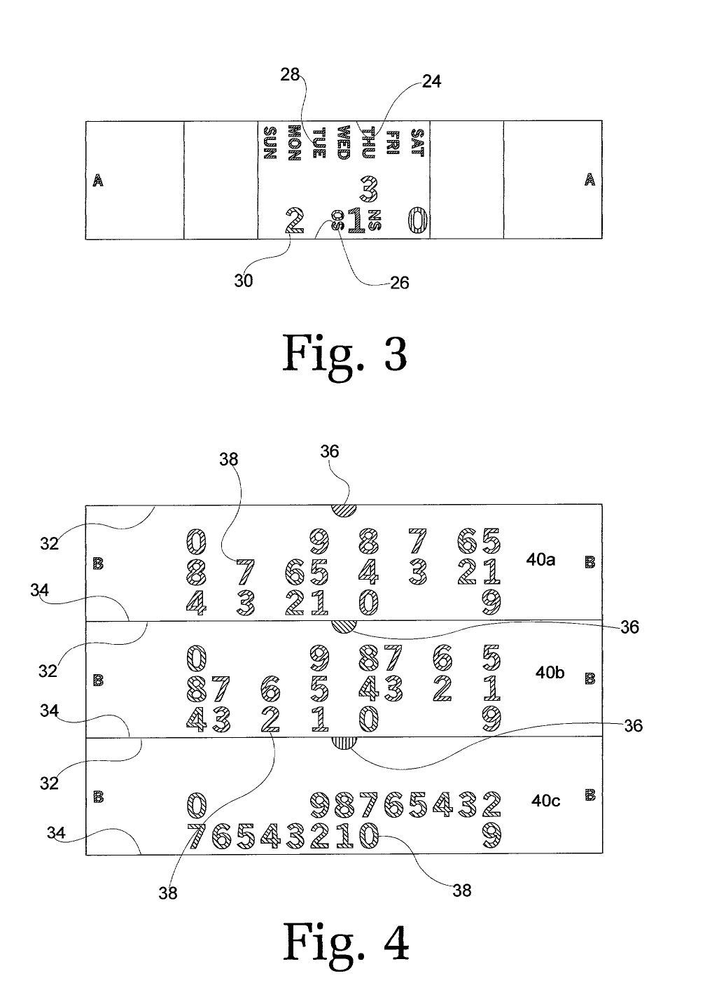

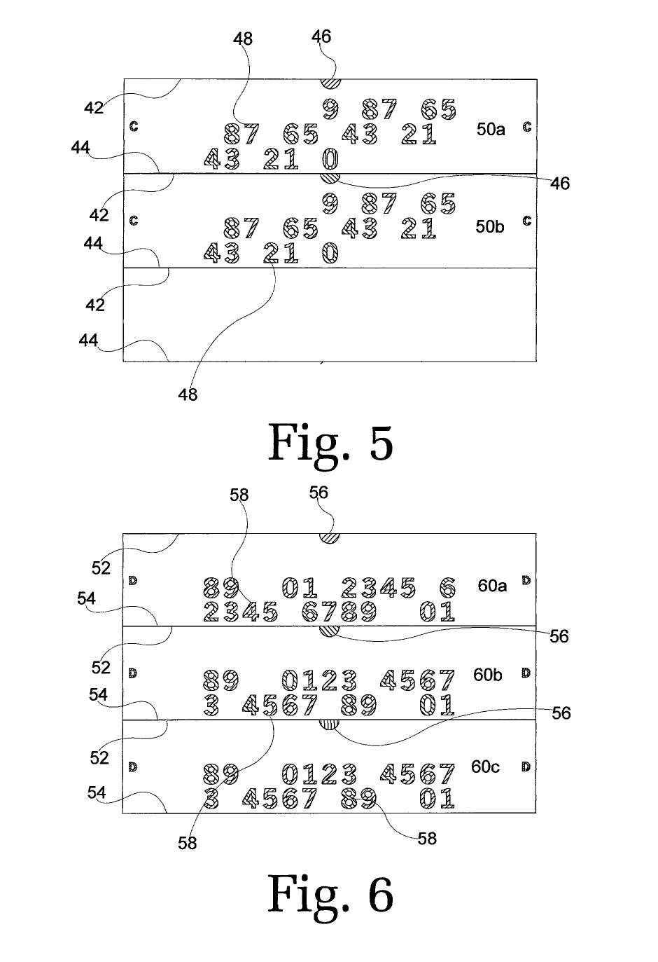

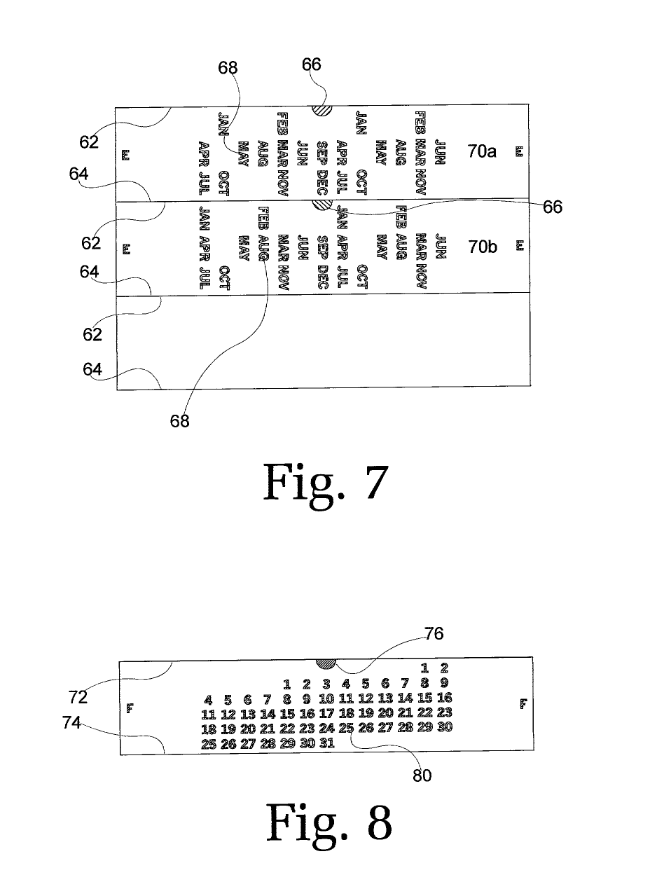

As seen, the first body member 12 has a first side 24 and a second side 26. The first side 24 of first body member has a first indicia 28 thereon. The second side 26 of the first body member 12 has second indicia 30 thereon for representing a a particular thousands digit of a year. The thousands digit of the year can correspond to either an old style date (before 1582 October 15) wherein the thousands indicia “1” will be accompanied by the indicia “OS” or a new style date (on or after 1582 October 15) wherein the thousands indicia “1” will be accompanied by the indicia “NS.” Each of the plurality of thousands year indicia 30 will be in one of several colors (for purposes of illustration, different hatch markings have been placed on the various indicia in FIGS. 2-8, such that each particular hatch marking corresponds to a unique color of that indicia. The particular color is not important, only the difference in colors between the selections of one body member and the indicator of the next body member).

The second body member 14 has a third side 32 and a fourth side 34. The third side 32 of second body member 14 has a third indicia 36 for aligning with the desired second indicia 30. The fourth side 34 of the second body member 14 has a fourth indicia 38 thereon for representing a particular hundreds digit of a year. As seen, the second body member 14, by being generally triangular, has three faces 40a, 40b, and 40c, and each of the three faces 40a, 40b, and 40c has a third side 32 with a third indicia 36 thereon and a fourth side 34 with a plurality of hundreds year indicia 38 thereon. As seen, the third indicia 36 on the first face 40a is of a different color relative to the third indicia 36 on the second face 40b and the third indicia 36 on the third face 40c is of a different color relative to the color of the third indicia 36 on the first face 40a and the third indicia 36 on the second face 40b.

The third body member 16 has a fifth side 42 and a sixth side 44. The fifth side 42 of third body member 16 has a fifth indicia 46 for aligning with the fourth indicia 38. The sixth side 44 of the third body member 16 has sixth indicia 48 thereon for representing a particular tens digit of a year. As seen, the third body member 16, by being generally triangular, has three faces 50a, 50b, and 50c, and two of the three faces 50a and 50b have a fifth side 42 with fifth indicia 46 thereon and a sixth side 44 with a plurality of tens year indicia 48 thereon. As seen, the fifth indicia 46 on the first face 50a is of a different color relative to the fifth indicia 46 on the second face 50b.

The fourth body member 18 has a seventh side 52 and an eighth side 54. The seventh side 52 of fourth body member 18 has a seventh indicia 56 for aligning the sixth indicia 48. The eighth side 54 of the fourth body member 18 has eight indicia 58 thereon for representing a particular single digit of a year. As seen, the fourth body member 18, by being generally triangular, has three faces 60a, 60b, and 60c, and each of the three faces 60a, 60b, and 60c has a seventh side 52 with a seventh indicia 56 thereon and an eighth side 54 with a plurality of year indicia 58 thereon. As seen, the seventh indicia 56 on the first face 60a is of a different color relative to the seventh indicia 56 on the second face 60b and the seventh indicia 56 on the third face 60c is of a different color than the seventh indicia 56 on the first face 60a and the seventh indicia 56 on the second face 60b.

The fifth body member 20 has a ninth side 62 and a tenth side 64. The ninth side 62 of fifth body member 20 has a ninth indicia 66 for aligning with the eight indicia 58. The tenth side 64 of the fifth body member 20 has tenth indicia 68 thereon for representing a particular month. As seen, the fifth body member 20, by being generally triangular, has three faces 70a, 70b, and 70c, and two of the three faces 70a, and 70b have a ninth side 62 with a ninth indicia 66 thereon and a tenth side 64 with a plurality of months indicia 68 thereon. As seen, the ninth indicia 66 on the first face 70a is of a different color relative to the fourth indicator 66 on the second face 70b.

The sixth body member 22 has an eleventh side 72 and a twelfth side 74. The eleventh side 72 of sixth body member 22 has eleventh indicia 76 for aligning with the tenth indicia 68. The twelfth side 74 of the sixth body member 22 has twelfth indicia thereon 80, such as a plurality of numbers to represent a particular day of the month.

In order to use the hexagonal slide ruler 10 of the present invention, the second body member 14 is moved so that the third indicia 36 is aligned with the second indicia 30 (thousands year) for the second indicia that is of interest. The color of the third indicia 36 must match the color of the second indicia 30 that it is aligning with. If necessary, the second body member 14 is either turned or flipped so that the face 40a, 40b, or 40c of the second body member 14 that has the particular color of the third indicia 36 desired, is positioned adjacent the first body member 12 allowing the third indicia 36 to align with the desired second indicia 30.

The third body member 16 is moved so that the fifth indicia 46 is aligned with the fourth indicia 38 (hundreds year) for the fourth indicia that is of interest. The color of the fifth indicia 46 must match the color of the fourth indicia 38 that is selected. If necessary, the third body member 16 is turned so that the face 50a, 50b, or 50c of the third body member 16 that has the particular color of the fifth indicia 46 desired, is positioned adjacent the second body member 14 allowing the fifth indicia 46 to align with the desired fourth indicia 38.

The fourth body member 18 is moved so that the seventh indicia 56 is aligned with the sixth indicia 48 (tens year) for the sixth that is of interest. The color of the seventh indicia 56 must match the color of the sixth indicia 48 that is selected. If necessary, the fourth body member 18 is turned or flipped so that the face 60a, 60b, or 60c of the fourth body member 18 that has the particular color of seventh indicia 56 desired, is positioned adjacent the third body member 16 allowing the seventh indicia to align with the desired sixth indicia 48.

The fifth body member 20 is moved so that the ninth indicia 66 is aligned with the eight indicia 58 (year) for the single digit of the eight indicia that is of interest. The color of the ninth indicia 66 must match the color of the eight indicia 58 that is selected. If necessary, the fifth body member 20 is turned so that the face 70a or 70b of the fifth body member 20 that has the particular color desired, is positioned adjacent the fourth body member 18 allowing the ninth indicia 66 to align with the desired eight indicia 58.

The sixth body member 22 is moved so that the eleventh indicia 76 is aligned with the tenth indicia 68 (month) for the tenth indicia that is of interest. The twelfth indicia 80 (day) on the twelfth side 74 of the sixth body member 22 are now positioned adjacent to the first side 24 of the first body member 12 and the twelfth indicia 80 (day) that are positioned on the twelfth side 74 so as to correspond to the first indicia (day of the week) as indicated by the first indicia 28 on the first side 24.

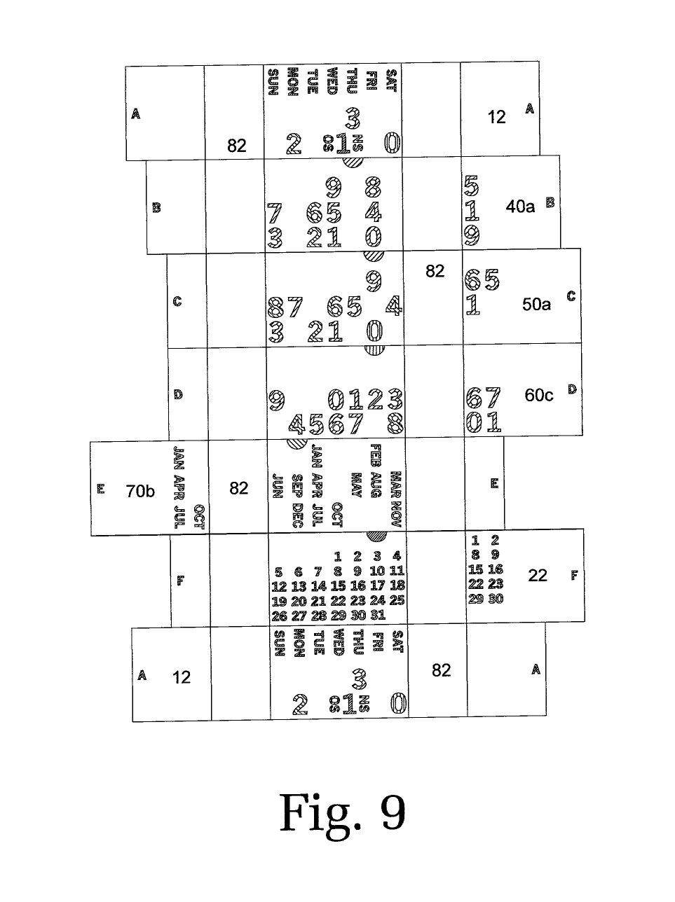

By way of example, FIG. 8, illustrates the day of the week for the date of 1964 January 29 (the first body member 12 being repeated for illustration purposes to show the sixth body member 22 adjacent the first body member 12).

In order to help position the body members 12, 14, 16, 18, 20, and 22 relative to one another, it is desirable that body members 12, 14, 16, 18, 20, and 22 be adapted to slide or otherwise move relative to each other. By way of example, at least one band 82 can be used to encompass the body members 12, 14, 16, 18, 20, and 22 with the individual body members 12, 14, 16, 18, 20, and 22 free to slide within the at least one band 82. If desired, each of the at least one band 82 can be fixedly attached to one of the body members 12, 14, 16, 18, 20, and 22 (preferably but not necessarily the first body member 12) so that it cannot be easily lost. As seen, each body member 12, 14, 16, 18, 20, and 22 has a unique identifying indicia 84 thereon for assisting in adjacency placement of the body members 12, 14, 16, 18, 20, and 22.

While the invention has been particularly shown and described with reference to an embodiment thereof, it will be appreciated by those skilled in the art that various changes in form and detail may be made without departing from the spirit and scope of the invention.

I claim:

1. A hexagonal slide ruler comprising:
a first body member having a first side having first indicia thereon and a second side having a second indicia thereon;
a second body member, having a third side with a third indicia thereon for aligning with the second indicia and a fourth side having fourth indicia thereon, adapted to move relative to the first body member;
a third body member, having a fifth side with fifth indicia thereon for aligning with the fourth indicia and a sixth side having sixth indicia thereon, adapted to move relative to the second body member;
a fourth body member, having a seventh side with seventh indicia thereon for aligning with the sixth indicia and an eighth side having eight indicia thereon, adapted to move relative to the third body member;
a fifth body member, having a ninth side with ninth indicia thereon for aligning with the eight indicia and a tenth side having tenth indicia thereon, adapted to move relative to the fourth body member; and
a sixth body member, having a eleventh side with eleventh indicia thereon for aligning with the tenth indicia and a twelfth side having twelfth indicia thereon adapted to correspond with the first indicia, adapted to move relative to the fifth body member and the first body member.

2. The hexagonal slide ruler as in claim 1 wherein the first face, the second face, and the third face are each generally rectangular.

3. The hexagonal slide ruler as in claim 1 further comprising at least one band such that each of the plurality of body members is disposed within the at least one band.

4. A hexagonal slide ruler, for calculating chronological cycles, comprising:
a first body member having a first side with a plurality of cyclical indicia thereon and a second side having a plurality of thousands year indicia thereon;
a second body member, having a third side with a first indicator thereon for selecting a respective one of the thousands year indicia and a fourth side having a plurality of hundred year indicia thereon, adapted to move relative to the first body member;
a third body member, having a fifth side with a second indicator thereon for selecting a respective one of the hundreds year indicia and a sixth side having a plurality of tens year indicia thereon, adapted to move relative to the second body member;
a fourth body member, having a seventh side with a third indicator thereon for selecting a respective one of the tens year indicia and an eighth side having a plurality of year indicia thereon, adapted to move relative to the third body member;
a fifth body member, having a ninth side with a fourth indicator thereon for selecting a respective one of the year indicia and a tenth side having a plurality of month indicia thereon, adapted to move relative to the fourth body member; and
a sixth body member, having a eleventh side with a fifth indicator thereon for selecting a respective one of the plurality of month indicia and a twelfth side having a plurality of day indicia thereon adapted to correspond with a respective one of the cyclical indicia, adapted to move relative to the fifth body member and the first body member.

5. The hexagonal slide ruler as in claim 4 wherein the first body member, the second body member, the third body member, the fourth body member, the fifth body member, and the sixth body member each have at least one face that is generally rectangular.

6. The hexagonal slide ruler as in claim 4 wherein the first body member, the second body member, the third body member, the fourth body member, the fifth body member, and the sixth body member are each generally triangular members.

7 The hexagonal slide ruler as in claim 6 further comprising at least one band such that each of the first body member, the second body member, the third body member, the fourth body member, the fifth body member, and the sixth body member are disposed within the at least one band.

8. The hexagonal slide ruler as in claim 6 wherein the first body member, the second body member, the third body member, the fourth body member, the fifth body member, and the sixth body member are disposed within the at least one band are generally arranged in a generally hexagonal orientation.

9. The hexagonal slide ruler as in claim 4 further comprising at least one band such that each of the first body member, the second body member, the third body member, the fourth body member, the fifth body member, and the sixth body member are disposed within the at least one band.

10. The hexagonal slide ruler as in claim 9 wherein the first body member, the second body member, the third body member, the fourth body member, the fifth body member, and the sixth body member are generally arranged in a generally hexagonal orientation.

11. The hexagonal slide ruler as in claim 4 wherein the thousands year indicia represent both BC and AD years.

12. The hexagonal slide ruler as in claim 4 wherein the particular date includes both old style dates before 1582 October 15, and new style dates on or after 1582 October 15.

13. The hexagonal slide ruler as in claim 4 wherein the fifth indicator has a plurality of gradations thereon.

14. A hexagonal slide ruler comprising a plurality of body members, each body member having a triangular cross-section and each having at least one face, such that the plurality of body members are banded together to form a generally hexagonal arrangement and the plurality of body members are capable of sliding relative to one another.

15. The hexagonal slide ruler as in claim 14 wherein each face on each of the plurality of body members is generally rectangular.

16. The hexagonal slide ruler as in claim 14 further comprising indicia disposed on at least one face of each of the plurality of body members such that the indicia on one body member interacts with indicia on adjacent body members.
